(19) United States
(12) Patent Application Publication
(10) Pub. No.: US 2016/0178169 A1
(43) Pub. Date: Jun. 23, 2016

(54) ADAPTER DEVICE FOR RETROFITTING IN LIGHTING ARRANGEMENTS

(71) Applicant: KONINKLIJKE PHILIPS N.V., Eindhoven (NL)

(72) Inventors: Merijn KESER, Eindhoven (NL); Erik Adrianus Andreas DE JONG, Best (NL)

(73) Assignee: KONINKLIJKE PHILIPS N.V., EINDHOVEN (NL)

(21) Appl. No.: 14/773,783

(22) PCT Filed: Mar. 5, 2014
(86) PCT No.: PCT/IB2014/059446

§ 371 Date: Sep. 9, 2015

Related U.S. Application Data
(60) Provisional application No. 61/775,826, filed on Mar. 11, 2013.

(51) Int. Cl. F21V 19/00; F21K 99/00; H01R 33/08; F21V 23/06

(52) U.S. Cl. CPC F21V 19/0085; F21V 23/06; F21K 9/17; F21V 19/001; H01R 33/08; F21Y 2103/003

(57) ABSTRACT

An adapter device (100) for releasable attachment of a lighting module in a luminaire. The adapter device comprises at least one resilient element (110, 110a, 110b) arranged to abut the lighting module. The adapter device further comprises an electrical interface (120), arranged for electrical connection to the luminaire, wherein the electrical interface is mechanically engageable with the at least one resilient element. At least a portion (130) of the electrical interface is rotatably arranged in the adapter device and comprises an arm portion (160) which elongates in a rotational plane of the at least one portion of the electrical interface. The arm portion is arranged to bias the at least one resilient element dependently on the rotation of the at least one portion of the electrical interface, such that the at least one resilient element, in a biased state, is arranged to clamp the lighting module to the luminaire.

### FIELD OF THE INVENTION

The present invention generally relates to an adapter device. More specifically, the adapter device relates to retrofitting in lighting arrangements.

### BACKGROUND OF THE INVENTION

The use of light-emitting diodes (LED) for illumination purposes continues to attract attention. Compared to incandescent lamps, fluorescent lamps, neon tube lamps, etc., LEDs provide numerous advantages such as a longer operational life, a reduced power consumption, and an increased efficiency related to the ratio between light energy and heat energy.

Due to the advantageous aspects of the use of LEDs, the interest has rapidly increased to replace conventional light sources with LEDs in many lighting arrangements, also called retrofitting. It will be appreciated that LEDs may replace conventional light sources in virtually any kind of lighting, e.g. commercial or domestic lighting arrangements, advertising signs, traffic signals, exit signs, etc. The light source replacement (retrofitting) is often performed by removing the conventional light source(s) from the luminaire (e.g. a lamp holder) of the lighting arrangement and attaching the LEDs, LED arrangement(s) or LED device(s) into the luminaire.

During retrofitting, LED devices/arrangements are often attached to the luminaires by attachment means such as screws or the like, and extra holes often need to be provided in the luminaire for the attachment of the LED devices. In practice, this may lead to a new luminaire design or to a redesign of the existing luminaire. However, to achieve a faster and more convenient retrofitting operation, it is desirable to avoid any modifications of the luminaire such that the LED devices may replace the conventional light sources in the originally designed luminaire.

In U.S. Pat. No. 7,488,086, a method and device for replacing a fluorescent tube lamp with a LED lamp is shown. The LED lamp includes an elongated electrical assembly having ends terminating in first and second electrical connectors, and a plurality of LEDs mounted to the elongated electrical assembly. Mounting adaptors connect with the first and second electrical connectors, and have bi-pin connectors to connect with conventional lamp socket connectors. The mounting adaptors have rotating connectors for connecting with the first and second electrical connectors of the LED lamp, so that the LED lamp orientation can be rotated after the LED lamp is fully mounted to the lamp socket connectors.

However, the mounting of the LED lamp is still complicated, awkward and circumstantial. When fitting the LED lamp in the lamp fixture, the mounting adaptors themselves need to be adjusted by adjusting the distance between rotating connectors and bi-pin connectors. Furthermore, the shown device does not provide a satisfactory fastening of the LED lamp in the lamp fixture. As a consequence, the fitting of the LED lamp in the lamp fixture according to the prior art leads to a slow and complicated operation. Hence, alternative solutions are of interest such that a more convenient, faster and more robust retrofitting is achieved.

### SUMMARY OF THE INVENTION

It is an object of the present invention to mitigate at least some of the above problems and to provide an adapter device which provides a convenient, fast and robust retrofitting.

This and other objects are achieved by providing an adapter device having the features in the independent claim. Preferred embodiments are defined in the dependent claims.

Hence, according to the present invention, there is provided an adapter device for releasable attachment of a lighting module in a luminaire. The adapter device comprises at least one resilient element arranged to abut the lighting module. The adapter device further comprises an electrical interface, arranged for electrical connection to the luminaire, wherein the electrical interface is mechanically engageable with the at least one resilient element. At least a portion of the electrical interface is rotatably arranged in the adapter device and comprises an arm portion which elongates in a rotational plane of the at least one portion of the electrical interface. The arm portion is arranged to bias the at least one resilient element dependently on the rotation of the at least one portion of the electrical interface, such that the at least one resilient element, in a biased state, is arranged to clamp the lighting module to the luminaire.

Thus, the present invention is based on the idea of providing an adapter device for an easy, convenient and robust attachment of a light module in a luminaire. The electrical interface (or at least a portion thereof) is able to rotate in the adapter device, and the arm portion of the electrical interface is able to bias the resilient element dependently on the rotation of the electrical interface. In turn, the biased resilient element clamps the lighting module to the luminaire. Hence, the adapter device provides an easy and convenient attachment of the lighting module to (in) the luminaire upon rotation of the electrical interface.

An advantage of the present invention is that the adapter device provides an attachment of the lighting module in the luminaire without a need to adjust the luminaire for the mounting of the lighting module in the luminaire. As the adapter device is able to clamp the lighting module in the luminaire by means of the force from the biased resilient element, the luminaire does not need to be adjusted for the purpose of attaching the lighting module to the luminaire. If fastening means common in the prior art are used for the attachment of the lighting module, such as screws or the like, the luminaire may have to be adjusted, modified and/or redesigned. In contrast, the adapter device of the present invention provides a lighting module attachment without any further need of luminaire adjustment. For the purpose of retrofitting, wherein a lighting module (e.g. comprising LEDs) is arranged to replace one or more conventional light sources in a luminaire, the adapter device of the present invention ensures that the same luminaire for holding the previously arranged conventional light sources is also able to hold the new lighting module. As the adapter device may render any luminaire adjustment unnecessary, thereby allowing a use of present technology/methods, arrangements and/or components, both time and tooling costs are saved for the luminaire and lighting module customer and/or installer. Furthermore, it will be appreciated that the adapter device is able to facilitate the logistics of the luminaire and/or lighting module. For example, one or more luminaires may firstly be (completely) assembled and/or mounted in an indoor or outdoor setting. Then, it may be decided what kind of lighting module to arrange in the luminaire, wherein the lighting module is arranged in the luminaire by means of the adapter device of the present invention.

The present invention is further advantageous in that the adapter device provides an easy, convenient and intuitive operation for attaching a lighting module to a luminaire. After arranging the lighting module in the luminaire, the adapter device is connected to the luminaire by the electrical interface. Then, the electrical interface is rotated, whereby the arm portion forces the resilient element to clamp the lighting module to the luminaire. Devices/arrangements in the prior art for retrofitting purposes often have a complex and complicated construction, and an arrangement of a lighting module in a light fixture by means of these devices often becomes circumstantial and awkward. In contrast, the adapter device of present invention easily and quickly attaches the lighting module to the luminaire by a simple rotation (turning) of the electrical interface when connected to the luminaire. The quick, easy and convenient retrofitting operation provided by the adapter device is especially advantageous in a case the lighting armature is not readily accessible. For example, light source replacement in indoor luminaires (e.g. in a home, an office, a store, etc.) and/or in outdoor luminaires (e.g. in advertising signs, exits signs, etc.) may be difficult, as both indoor and outdoor luminaires may be elevated and/or suspended in such a way that the retrofitting operation becomes awkward and circumstantial. The adapter device of the present invention, on the other hand, facilitates the retrofitting by its convenient configuration and operation.

It will be appreciated that the adapter device of the present invention comprises relatively few components. The low number of components is advantageous in that the adapter device is relatively inexpensive to fabricate. Moreover, the low number of components of the carrier structure implies an easier recycling, especially compared to devices comprising a relatively high number of components which impede an easy disassembling and/or recycling operation.

The adapter device of the present invention comprises at least one resilient element. By “resilient element”, it is here meant substantially any resilient or elastic element such as a spring, coil, (spring) clip, elastomeric material, or the like. At least a portion and/or an end of the resilient element is arranged to come into contact with (abut) a lighting module arranged in a luminaire.

The adapter device further comprises an electrical interface arranged for electrical connection to the luminaire. By “electrical interface”, it is here meant an electrical connector, plug, or the like. The electrical interface may, for example, be a male contact for electrical connection to a female contact (socket) of the luminaire. Furthermore, the electrical interface is mechanically engageable with the at least one resilient element. In other words, the electrical interface is arranged (adapted) to come into contact with the resilient element. At least a portion of the electrical interface is rotatably arranged in the adapter device. In other words, the (at least a portion) of the electrical interface may be arranged in the adapter device such that it may be rotated. For example, the adapter device may comprise a rotational connection between the adapter device and the electrical interface.

The electrical interface comprises an arm portion which elongates in a rotational plane of the at least one portion of the electrical interface. In other words, the at least a portion of the electrical interface is rotatable in a plane, and the arm portion elongates (has an oblong shape) in this plane. The arm portion is arranged to bias the at least one resilient element dependently on the rotation of the at least one portion of the electrical interface. Hence, upon rotation of the arm portion, the arm portion may bias (compress) the resilient element dependently on the position and/or rotational direction of the arm portion, e.g. into a biased (compressed state) of the resilient element. Analogously, the arm portion may decompress (unbias) the resilient element dependently on the position and/or rotational direction of the arm portion, e.g. into a decompressed (unbiased) state of the resilient element. Upon attachment of a lighting module in a luminaire by means of the adapter device, the resilient element is, in its biased state, arranged (adapted) to clamp the lighting module to the luminaire. Analogously, the arm portion may unclamp the resilient element by a rotation of the arm portion and set the resilient element into an unbiased state, whereby the lighting module may be removed from the luminaire.

According to an embodiment of the present invention, the at least a portion of the electrical interface may be formed integrally with the electrical interface. In other words, the at least a portion of the electrical interface may be formed in one piece with the electrical interface, whereby the (entire) electrical interface is rotatably arranged in the adapter device. The present embodiment is advantageous in that the adapter device, comprising a one-piece electrical interface, is conveniently and easily operated. Upon attachment of a lighting module in a luminaire, the electrical interface of the adapter device may be electrically connected to the luminaire. Then, the electrical interface may be turned in the luminaire, and the adapter device may clamp the lighting module to the luminaire. For example, the electrical interface (e.g. a plug) may be connected to a corresponding electrical interface of the luminaire (e.g. a socket), and the plug may be rotated in the (rotatable) socket while clamping the lighting module to the luminaire. The present embodiment is further advantageous in that a one-piece electrical interface is conveniently and easily produced.

According to an embodiment of the present invention, the at least a portion of the electrical interface may be rotatably arranged with respect to the electrical interface. In other words, the adapter device may comprise a rotatable connection between the portion of the electrical interface and the electrical interface. The present embodiment is advantageous in that the portion of the electrical interface may be rotated (turned) independently of the connection between the electrical interface and the luminaire, for a clamping of a lighting module to a luminaire. For example, if the electrical interface of the luminaire (e.g. a socket) is non-rotatable, the electrical interface (e.g. a plug) may be connected to the electrical interface of the luminaire. Then, the portion of the electrical interface may be rotated (turned) to clamp the lighting module to the luminaire, while the remaining part of the electrical interface, i.e. the part of the electrical interface other than said portion, is connected to the luminaire in a non-rotatable manner.

According to an embodiment of the present invention, the at least a portion of the electrical interface may have an oblong shape, and wherein the arm portion is defined by at least a portion of the long dimension of the oblong shape. By “oblong shape”, it is here meant a shape which is oval, elliptic, rectangular, or the like, and the arm portion of the electrical interface is defined by (constitutes) at least a portion of the long dimension of the shape.

According to an embodiment of the present invention, the at least a portion of the electrical interface may be rotatable by at least 90°, and wherein a rotation of 90° of the at least a portion of the electrical interface may bias the at least one resilient element into the biased state. Hence, the portion of the electrical interface may be rotatable clockwise or anti-clockwise by at least 90°, e.g. 90°, 180° and/or 360°. Furthermore, a rotation of 90° of the at least a portion of the electrical interface may bias the at least one resilient element into a biased state, or analogously, unbias the at least one resilient element into an unbiased state. For example, if the at least a portion of the electrical interface has an oblong shape, the short dimension of the oblong shape may face and/or be in contact with the resilient element in its unbiased state. Then, upon rotation of the portion of the electrical interface, the radius of the portion of the electrical interface increases in a direction towards the resilient element, and upon a rotation of 90°, the long dimension of the oblong shape (the arm portion) is in contact with the resilient element and compresses the resilient element in its biased state. Analogously, by rotating the portion of the electrical interface ±90° from the biased state of the resilient element, the resilient element may be rotated/turned into its unbiased state. The present embodiment is advantageous in that the at least a portion of the electrical interface of the adapter device may be easily and conveniently rotated (turned) for a clamping/unclamping of a lighting module to a luminaire.

According to an embodiment of the present invention, the electrical interface may comprise at least one electrical plug with male contacts for electrical connection with the luminaire. The present embodiment is advantageous in that luminaires often are provided with a female contact for electrical connection, and that the adapter device hereby may be conveniently connected to a large number of available luminaires without the need of further adapters for electrical connection. Furthermore, the electrical plug of the electrical interface may be conveniently inserted into the rotatable or non-rotatable electrical interface (e.g. a socket) of the luminaire to further ensure a relatively firm mechanical connection between the adapter device and the luminaire.

According to an embodiment of the present invention, the at least one resilient element may be a leaf spring. By “leaf spring”, it is here meant an arched, substantially semi-elliptical spring. The electrical interface is mechanically engageable with the leaf spring, and the (elongated) arm portion of the electrical interface is arranged to engage with (act upon) an arched portion of the leaf spring to bias the spring upon rotation of the portion of the electrical interface. Furthermore, the end portions of the leaf spring may be arranged to abut the lighting module, such that the leaf spring, in its biased state, may exert a clamping force on the lighting module through the end portions.

According to an embodiment of the present invention, the at least one resilient element may be electrically conductive and electrically connectable to the electrical interface for electrical connection of the electrical interface with the lighting module. In other words, the resilient element may be arranged to conduct electricity between the electrical interface and the lighting module. The present embodiment is advantageous in that the at least one resilient element may simultaneously be arranged to provide a clamping force on a lighting module in a luminaire as well as being arranged to supply electricity to the lighting module when arranged in the luminaire. It will be appreciated that the at least one resilient element may be arranged to abut (come into contact with) electrical contact surfaces of the lighting module, when the resilient element is in its biased state to clamp the lighting module to the luminaire. The resilient element may hereby conduct electricity to the lighting module via the electrical contact surfaces of the lighting module.

According to an embodiment of the present invention, the adapter device may comprise at least one fastening means for releasable attachment of the adapter device to the luminaire. By “fastening means” it is hereby meant substantially any means for releasable attachment of the adapter device to the luminaire, such as hooks, clutches, or the like. The present embodiment is advantageous in that the electrical interface of the adapter device may be firmly held in place in the luminaire by the at least one fastening means.

According to an embodiment of the present invention, the adapter device may comprise a housing element at least partly enclosing one or more parts of the adapter device. It will be appreciated that the housing element may enclose the at least a portion of the electrical interface, and that the portion of the electrical interface may be rotatably arranged in the housing element. Furthermore, the at least one resilient element may be attached (fixed) to the housing element. The present embodiment is advantageous in that the housing element provides an increased stability of the adapter device when mounted to attach a lighting module to a luminaire. The housing element may further protect the lighting module from damage, dust, rain, etc.

According to an embodiment of the present invention, the housing element may comprise at least one optical element. In other words, the housing element may, at least partially, serve as an optical cover, or the like, for a lighting module arranged in a luminaire. Furthermore, if the housing element is formed, at least partially, as an optical element or cover, the housing element may provide substantially any sought effect of the light emanating from the lighting module upon operation, such as color, reflection properties, etc.

According to an embodiment of the present invention, there is provided a lighting device comprising a luminaire. The lighting device further comprises a lighting module arranged in the luminaire, wherein the lighting module comprises at least one light source. The lighting device further comprises at least one adapter device according to any one of the previous embodiments for releasable attachment of the lighting module in the luminaire. The advantages of the adapter device have been described in previous parts of the text, and it is hereby referred to these parts.

According to an embodiment of the present invention, the lighting module of the lighting device may comprise at least one light-emitting diode (LED) and the luminaire of the lighting device may be a tube lamp luminaire. In other words, the luminaire of the lighting device may have been initially arranged to hold a tube lamp, or the like, whereas the tube lamp has been replaced by a LED lighting module by retrofitting. The present embodiment is advantageous in that the adapter device(s) according to the present invention is (are) able to provide an attachment of a LED lighting module in a tube lamp luminaire which may not have been initially intended to hold/accommodate a LED lighting module. The at least one adapter device is able to conveniently clamp the LED lighting module in the tube lamp luminaire by means of the force from the biased resilient element of the adapter device. Consequently, the tube lamp luminaire does not need to be adjusted for the purpose of attaching the LED lighting module to the tube lamp luminaire. Hence, for the purpose of retrofitting, wherein in this case, a LED lighting module is arranged to replace a tube lamp in a luminaire, the adapter device of the present invention ensures that the same tube lamp luminaire for holding the previously arranged tube lamp is also able to hold the LED lighting module.

According to an embodiment of the present invention, the luminaire of the lighting device may comprise at least one socket and the electrical interface of the adapter device may comprise at least one electrical plug for electrical connection to the at least one socket, wherein the at least one socket is rotatably arranged in the luminaire. The present embodiment is advantageous in that the electrical plug of the adapter device, of which at least a portion is rotatable, may be conveniently connected to the correspondingly rotatable socket of the luminaire.

According to an embodiment of the present invention, the at least one resilient element may be electrically conductive and electrically connectable to the electrical interface. The lighting module of the lighting device may further comprise at least one electrical contact surface for the at least one resilient element, such that the electrical interface is electrically connectable with the lighting module via the at least one resilient element and the at least one electrical contact surface. In other words, the resilient element may be arranged to conduct electricity between the electrical interface and the lighting module of the lighting device via the resilient element(s) and the electrical contact surface(s) of the lighting module. The at least one resilient element is hereby arranged to abut (come into contact with) the electrical contact surface(s) of the lighting module, when the resilient element is in its biased state to clamp the lighting module to the luminaire. The present embodiment is advantageous in that the adapter device of the lighting device may simultaneously be arranged to provide a clamping force on a lighting module in a luminaire as well as being arranged to supply electricity to the lighting module when arranged in the luminaire.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1a-i are schematic views of an adapter device according to exemplifying embodiments of the present invention;

FIG. 2 is a schematic, cross-sectional view of an adapter arrangement comprising at least one adapter device according to an exemplifying embodiment of the present invention; and

FIG. 3 is a schematic, cross-sectional view of a lighting device comprising at least one adapter device according to an exemplifying embodiment of the present invention.

### DETAILED DESCRIPTION

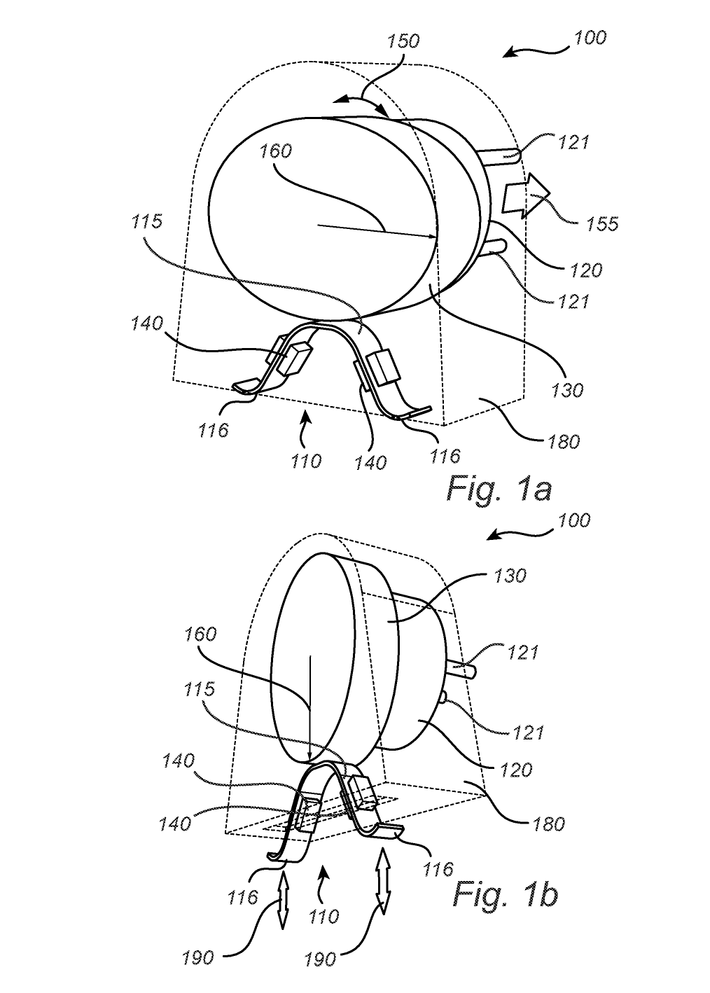

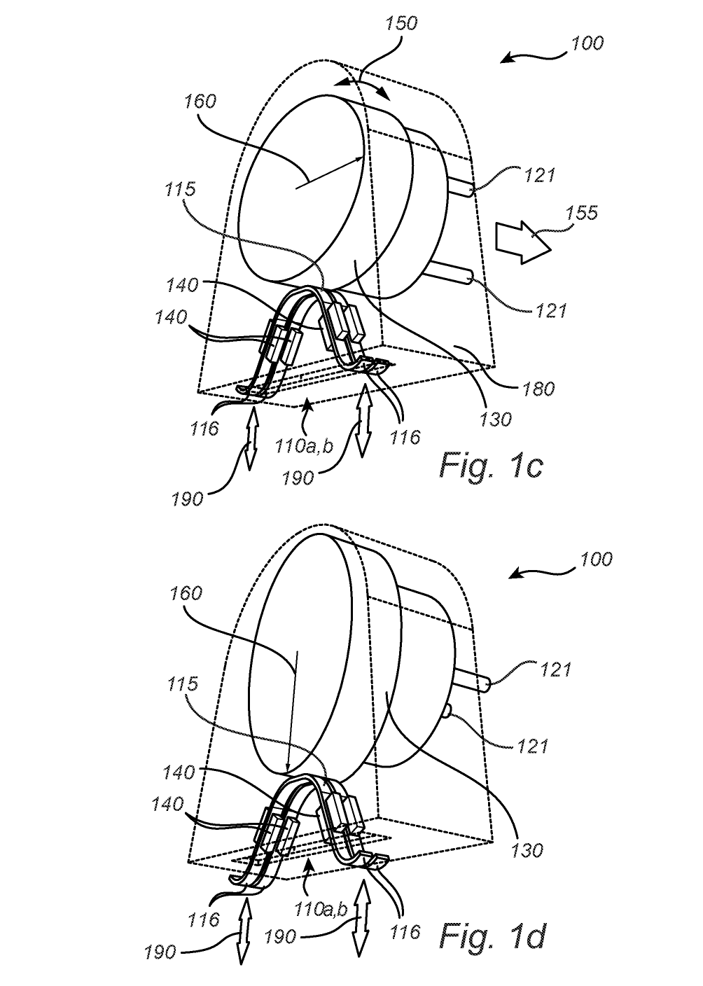

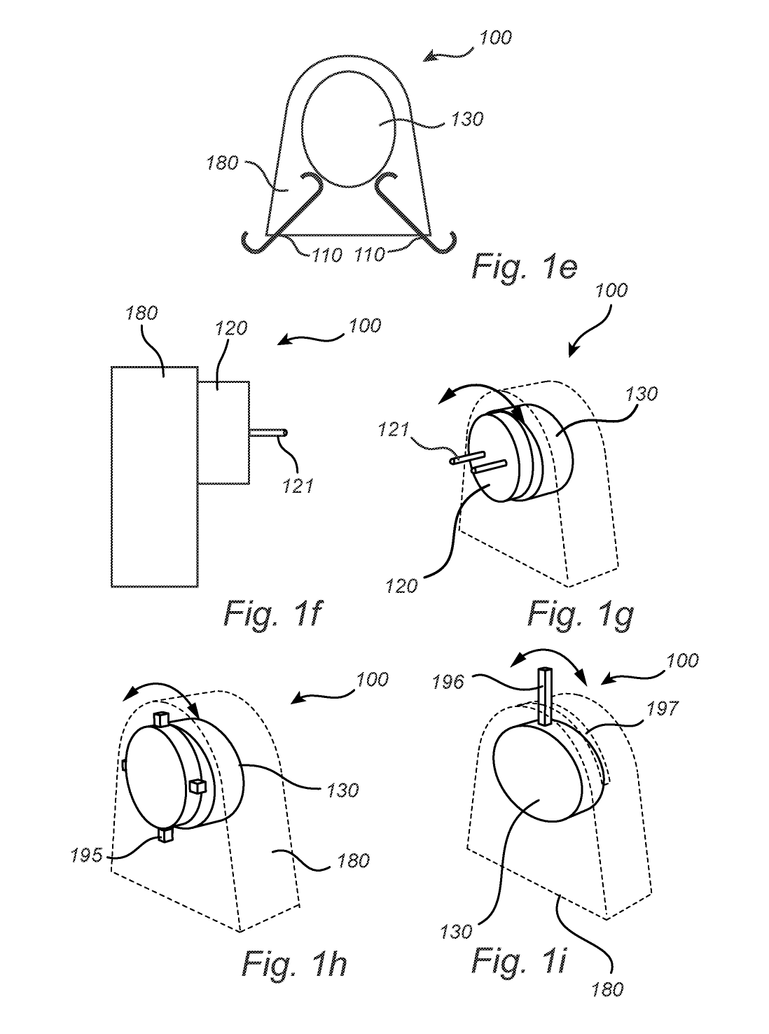

FIG. 1a is a schematic view of an adapter device 100 according to an exemplifying embodiment of the present invention. The adapter device 100 comprises a resilient element 110. The resilient element 110 in FIG. 1a is exemplified as a leaf spring 110, comprising an arched portion 115 and two end portions 116. It will be appreciated that the resilient element 110 may be substantially any resilient or elastic element such as a spring, coil, (spring) clip, elastomeric material, or the like. The resilient element 110 may be fastened to the adapter device 100 by fastening elements 140, here exemplified by a pair of clips 140. Alternatively, the resilient element 110 may be connected or fastened to the adapter device 100 by other devices and/or arrangements. Furthermore, the resilient element 110 may be fastened to the adapter device 100 such that movement and/or play of the resilient element 110 is allowed, e.g. by a flexible connection of the resilient element 110 to the adapter device 100.

The adapter device 100 further comprises an electrical interface 120, shown as an electrical plug with two male contacts 121 at one end thereof. For example, the electrical interface 120 may be of a standard type, e.g. a standard tube lamp cap such as a T5 or a T8 cap. The electrical interface 120 is mechanically engageable with the resilient element 110. For example, the electrical interface 120 may be mechanically engageable with the resilient element 110 by at least a portion 130 of the electrical interface 120 (hereafter denoted interface portion 130), wherein the interface portion 130 is provided on the opposite side of the male contacts 121 of the electrical interface 120. It will be appreciated that the interface portion 130 may be in contact with the resilient element 110, as shown in FIG. 1a. Alternatively, there may be a (relatively small) gap between the interface portion 130 and the resilient element 110. The interface portion 130 of the electrical interface 120 faces the arched portion 115 of the leaf spring 110, and the interface portion 130 is mechanically engageable with the arched portion 115 of the leaf spring 110.

The interface portion 130 of the electrical interface 120 is rotatably arranged in the adapter device 100, indicated by arrow 150. Hence, the interface portion 130 is rotatable in a rotational plane 150 which is perpendicular to the direction 155 for electrical connection of the male contacts 121 of the electrical interface 120 into an electrical connection, e.g. a socket. By this arrangement, it will be appreciated that the electrical interface 120 comprising the male contacts 121 is arranged for an electrical connection, whereas the interface portion 130 does not necessarily take part in the electrical connection. In other words, the interface portion 130 may be separated from the electrical connection of the electrical interface 120.

The interface portion 130 comprises an arm portion 160 which elongates in the rotational plane 150 of the interface portion 130 of the electrical interface 120. The arm portion 160 is schematically indicated as the radius of the interface portion 130, wherein the interface portion 130 has an oblong (oval) shape in the rotational plane 150. It will be appreciated that the arm portion 160 may constitute or be defined by any part of the interface portion 130 or electrical interface 120 which elongates in the rotational plane 150. For example, the arm portion 160 may be defined by at least a portion of the long dimension of the oblong shape of the interface portion 130, e.g. the radius or diameter of the oblong shape of the interface portion 130. In FIG. 1a, the long dimension of the oblong interface portion 130 (hence also arm portion 160) is positioned horizontally, whereas the short dimension of the oblong interface portion 130 is positioned vertically.

The arm portion 160 is arranged to bias (pressurize) the at least one resilient element 110 dependently on the rotation of the interface portion 130 of the electrical interface 120. Hence, upon rotation of the interface portion 130 in the rotational plane 150, the arm portion 160 is arranged to act upon the resilient element 110 such that the resilient element 110 becomes biased. In other words, the resilient element 110 passes from an unbiased state to a biased state. By the exemplifying adapter device 100 in FIG. 1a, the arm portion 160 of the interface portion 130 is hereby able to force, push and/or compress the resilient element 110 into a biased state upon rotation of the interface portion 130. The adapter device 100 in FIG. 1a further comprises a housing element 180 which at least partly encloses one or more parts of the adapter device 100. It will be appreciated that the housing element 180, indicated by dashed lines, is only schematically shown. Hence, the housing element 180 may take on a different shape and/or size of that indicated in the figure. The housing element 180 may further be arranged to hold one or more parts of the adapter device 100, e.g. the at least one resilient element 110, the electrical interface 120, the interface portion 130 and/or the fastening elements 140.

FIG. 1b is a schematic view of the adapter device 100 according to FIG. 1a, wherein the interface portion 130 of the electrical interface 120 has been rotated such that the resilient element 110 is in a biased state as previously described. The interface portion 130 has been rotated 90° in a clock-wise direction from the position in FIG. 1a into the position in FIG. 1b. Here, the arm portion 160 of the interface portion 130 is bearing against the arched portion 115 of the spring 110 facing the interface portion 130. The resilient element 110 is hereby forced/compressed into its biased state by the arm portion 160. In turn, the biased resilient element 110 is able to provide a force in the direction of the arrows 190, i.e. away from the interface portion 130 in a downward direction. In FIG. 1b, the long dimension of the oblong interface portion 130 (hence also arm portion 160) is positioned vertically, whereas the short dimension of the oblong interface portion 130 is positioned horizontally. When the adapter device 100 is arranged/mounted for the purpose of attaching a lighting module in a luminaire, the interface portion 130 may be rotated to bias the resilient element 110 into the biased state, whereby the resilient element 110 clamps the lighting module to the luminaire. In FIG. 1b, the end portions 116 of the leaf spring 110 are arranged to abut a lighting module arranged in a luminaire, and when the leaf spring 110 is biased upon rotation of the interface portion 130, the leaf spring 110 clamps the lighting module to the luminaire by its end portions 116.

Analogously, the arm portion 160 is also arranged to unbias (depressurize) the at least one resilient element 110 dependently on the rotation of the interface portion 130 of the electrical interface 120. In other words, dependently on the rotation of the interface portion 130, the biased state of the resilient element 110 shown in FIG. 1b may be depressurized to the unbiased state of the resilient element 110 shown in FIG. 1a. As the operation to unbias the resilient element 110 merely implies the reverse operation for biasing the resilient element 110 as described above, a more detailed description is hereby omitted. Analogously, if the adapter device 100 is mounted for clamping a lighting module in a luminaire, the interface portion 130 may be rotated to unbias the resilient element 110 into the unbiased state, and the lighting module may thereafter be removed from the luminaire. Hence, when the leaf spring 110 is unbiased upon rotation of the interface portion 130 in FIG. 1b, the end portions 116 of the leaf spring 110 release their clamping force upon the lighting module. The lighting module may thereafter be removed from the luminaire.

It will be appreciated that the interface portion 130 of the electrical interface 120 of the adapter device 100 in FIGS. 1a-b may be formed integrally with the electrical interface 120. Hence, the interface portion 130 and the electrical interface 120 may be provided in one piece, such that a rotation of the electrical interface 120 also implies a rotation of the interface portion 130, or vice versa. This is shown in FIGS. 1a-b, wherein a rotation of the interface portion 130 also implies a rotation of the electrical interface 120 comprising the male contacts 121. The described embodiment is suitable for a connection of the adapter device 100 to a luminaire comprising an electrical connection which is rotatable. Alternatively, the interface portion 130 of the electrical interface 120 may be rotatably arranged with respect to the electrical interface 120. Hence, the connection between the interface portion 130 and the electrical interface 120 may, for example, be articulated or hinged, such that a rotation of the interface portion 130 does not imply any rotation of the interface portion 120. The embodiment is suitable when the adapter device 100 is to be connected to a luminaire comprising an electrical connection which is not rotatable.

The interface portion 130 of the electrical interface 120 may be rotatable by at least 90°. Hence, the interface portion 130 may be rotated back and forth (i.e. clockwise and anti-clockwise) at least 90°. The adapter device may further comprise at least one stop such that the interface portion 130 is only rotatable in the interval ±90°, wherein 0° implies a position of the interface portion 130 such that the resilient element 110 is unbiased (e.g. as shown in FIG. 1a, wherein the short dimension of the oblong interface portion 130 faces the resilient element 110), and wherein 90° implies a position of the interface portion 130 such that the resilient element 110 is biased (e.g. as shown in FIG. 1b, wherein the long dimension of the oblong interface portion 130 faces and biases the resilient element 110).

FIG. 1c is a schematic view of an adapter device 100 similar to that shown in FIG. 1a, wherein the at least one resilient element 110 is in an unbiased state. Here, however, the adapter device 100 comprises two resilient elements 110a, 110b. The resilient elements 110a, 110b are electrically conductive and electrically connectable to the electrical interface 120. For example, the resilient elements 110a, 110b may be connected via a (internal) circuit to the electrical interface 120. More specifically, the respective resilient elements 110a, 110b may be electrically connected to a respective male contact 121. Furthermore, the interface portion 130 of the electrical interface 120 may, for example, comprise two contact surfaces (not shown) which are arranged to come into contact with the respective resilient element 110a, 110b upon rotation of the interface portion 130.

FIG. 1d shows the adapter device of FIG. 1c after a previously described rotation of the interface portion 130 of the electrical interface 120. The interface portion 130 has been rotated such that the resilient elements 110a, 110b are in a biased state as previously described. Here, the resilient elements 110a, 110b of the adapter device 100 are able to provide an electrical connection between the electrical interface 120 and the resilient elements 110a, 110b, e.g. by an (internal) circuit and/or two contact surfaces (not shown) of the interface portion 130 which may be in contact with (abut) the respective resilient element 110a, 110b. If the adapter device 100 is mounted to clamp a lighting module to a luminaire, the adapter device 100 is hereby able to electrically connect the electrical interface 120 with the lighting module via the resilient elements 110a, 110b.

It will be appreciated that the adapter device 100 as shown in FIGS. 1a-d may comprise one or more fastening means (not shown) for releasable attachment of the adapter device 100 to a luminaire. The fastening means may be substantially any means for releasable attachment of the adapter device to the luminaire (or to a lampholder of the luminaire), such as one or more hooks, clutches, or the like.

FIG. 1e is a schematic view of an alternative form of the two resilient elements 110 of the adapter device 100 of FIGS. 1c-d. Here, the two resilient elements 110 have the form of staples, and are inclined towards each other. By this arrangement, the ends of the resilient elements 110 form a seat for the interface portion 130, whereas the opposite ends of the resilient elements 110 are arranged to abut the lighting module.

FIG. if shows the adapter device 100 of any of the embodiments of FIGS. 1a-d in a schematic profile view for an increased understanding. The housing element 180 holds and/or is connected to the electrical interface 120. The electrical interface 120, comprising male contacts 121, is arranged for the electrical connection of the adapted device 100. Analogously, FIG. 1g shows a schematic and perspective view of the adapter device 100 according to an embodiment of the present invention. Here, the rotation of the electrical interface 120 according to an embodiment of the present invention is shown, wherein the electrical interface 120 may be rotated e.g. in a socket or a lampholder.

It will be appreciated that the interface portion 130, as shown in FIGS. 1a-d, may be conveniently rotated by hand. Alternatively, the adapter device 100 may comprise any other means for a rotation of the interface portion 130, as schematically shown in FIGS. 1h-i. The interface portion 130 of the exemplifying adapter device in FIG. 1h comprises a plurality of grips 195, such that the interface portion 130 has the form of a knob, a steering (hand) wheel, or the like, for an easy and convenient rotation of the interface portion 130. Alternatively, as shown in FIG. 1i, the interface portion 130 of the adapter device 100 may comprise a (hand) lever 196 which protrudes from the interface portion 130 and through a slot 197 of the housing element 180. The interface portion 130 is hereby easily rotated by a rotation of the lever 196.

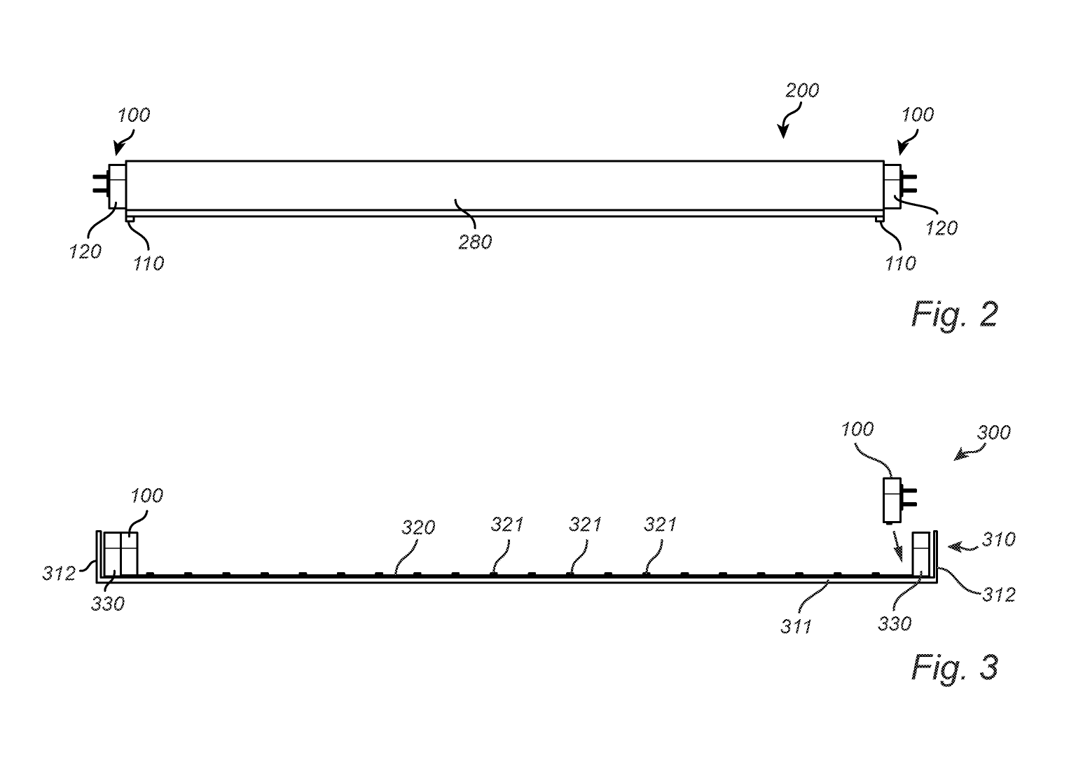

FIG. 2 is a schematic view of an adapter arrangement 200. The adapter arrangement 200 has an elongated structure and comprises two previously described adapter devices 100 provided at opposite ends of the adapter arrangement 200. The resilient element(s) 110 and the electrical interface 120 of the respective adapter device 100 are schematically depicted. The adapter arrangement 200 comprises a housing element 280 which is exemplified as an optical element 280 which elongates between the two adapter devices 100. It will be appreciated that the adapter arrangement 200 may be provided for releaseable attachment of a lighting module to a luminaire in a similar manner as for the adapter device 100 described above. In other words, the adapter devices 100 of the adapter arrangement 200 may be inserted into a luminaire and clamp a lighting module upon rotation of the interface portion of the adapter device. As the operation of the adapter device 100 has been thoroughly described above, it is hereby referred to those parts of the text. When mounted, the housing element 280 of the adapter device 100 of the adapter arrangement 200 may, at least partially, serve as an optical cover, or the like, for the lighting module arranged in the luminaire.

FIG. 3 is a schematic, cross-sectional view of a lighting device 300. The lighting device 300 comprises a luminaire 310 and a lighting module 320 which is arranged in the luminaire 310. The lighting module 320 comprises at least one light source 321, preferably at least one LED light source 321. Furthermore, the luminaire 310 may be a tube lamp luminaire 310. Hence, the conventional light source(s) (e.g. a tube lamp) has been removed from the luminaire 310 and a (LED) lighting module 320 has been arranged into the luminaire, wherein this operation is also known as retrofitting.

The luminaire 310 comprises a base portion 311 arranged to support the lighting module 320. The luminaire 310 further comprises side portions 312 arranged at the ends of the base portion 311, and which are substantially perpendicular to the base portion 311. The luminaire 310 in FIG. 3 further comprises two lamp holders 330, which may be tube lamp holders 330. The lamp holders 330 are arranged adjacent the side portions 312 of the luminaire 310 on either side of the lighting module 320.

The lighting device 300 further comprises at least one adapter device 100, as previously described, for releasable attachment of the lighting module 320 in the luminaire 310. The adapter device 100 may be mounted to the luminaire 310 and/or lighting module 320 by electrically connecting the electrical interface of the adapter device 100 to the luminaire 310, e.g. into the lamp holder 330. The luminaire 310 (or lamp holder 330) may comprise at least one socket (not shown), and the at least one socket may, for example, be rotatably arranged in the luminaire 310. The electrical interface of the adapter device 100 may hereby be connected to the at least one socket. The socket may be of a standard type, e.g.

for a reception of a standard electrical interface of the adapter device 100 such as a T5 or a T8 cap.

When the (at least one) adapter device 100 is connected to the luminaire 310 (lamp holder 330), the at least one resilient element of the adapter device 100 is arranged to come into contact with the lighting module 320. Furthermore, at least a portion of the electrical interface of the adapter device 100 is rotatably arranged in the adapter device 100. In contrast to conventional tube lamps, the adapter device 100 of the present invention may be configured so that only the (portion of the) electrical interface is arranged to rotate, whereas the (rest of the) adapter device 100 is fixed to the luminaire 310. Upon rotation of the electrical interface, the electrical interface is arranged to bias the resilient element. As a result, the resilient element (in its biased state) is arranged to clamp the lighting module 320 to the luminaire 310.

In FIG. 3, two adapter devices 100 are provided for releaseable attachment of the lighting module 320 to the luminaire, wherein the adapter devices 100 are arranged at opposite sides of the luminaire 310. It will be appreciated that a more detailed description of the function of the adapter device 100 has been described previously for the attachment (release) of the lighting module 320 in (from) the luminaire 310, and it is hereby referred to those parts of the text. The at least one resilient element (e.g. two resilient elements) of the adapter device 100 of the lighting device 300 may be electrically conductive and electrically connectable to the electrical interface of the adapter device 100. For example, the resilient elements may be connected via a (internal) circuit to the electrical interface. Furthermore, the lighting module 320 may comprise (two) electrical contact surfaces (not shown) for connection to the resilient elements, and the electrical contact surfaces may be provided on a printed circuit board (PCB) of the lighting module 320. By this, the electrical interface of the adapter device 100 is electrically connectable with the lighting module 320 via the resilient elements and the electrical contact surfaces. Hence, electric power may be provided to the area where two resilient elements come into contact with the PCB of the lighting module 320.

The person skilled in the art realizes that the present invention by no means is limited to the preferred embodiments described above. On the contrary, many modifications and variations are possible within the scope of the appended claims. For example, one or more of the resilient element(s) 110, 110a, 110b, the electrical interface 120, the interface portion 130, the housing element 180, 280, the luminaire 310, the lighting module 320, etc., may have different shapes, dimensions and/or sizes than those depicted/described.

1. An adapter device for releasable attachment of a lighting module in a luminaire, comprising
at least one resilient element, arranged to abut the lighting module, and
an electrical interface, arranged for electrical connection to the luminaire, wherein the electrical interface is mechanically engageable with the at least one resilient element,
wherein at least a portion of the electrical interface is rotatably arranged in the adapter device and comprises an arm portion which elongates in a rotational plane of the at least one portion of the electrical interface, wherein the arm portion is arranged to bias the at least one resilient element dependently on the rotation of the at least one portion of the electrical interface, such that the at least one resilient element, in a biased state, is arranged to clamp the lighting module to the luminaire.

2. The adapter device according to claim 1, wherein said portion of the electrical interface is formed integrally with the electrical interface.

3. The adapter device according to claim 1, wherein said portion of the electrical interface is rotatably arranged with respect to the electrical interface.

4. The adapter device according to claim 1, wherein said portion of the electrical interface has an oblong shape, and wherein the arm portion is defined by at least a portion of the long dimension of the oblong shape.

5. The adapter device according to claim 1, wherein said portion of the electrical interface is rotatable by at least 90°, and wherein a rotation of 90° of said portion of the electrical interface biases the at least one resilient element into the biased state.

6. The adapter device according to claim 1, wherein the electrical interface comprises at least one electrical plug with male contacts for electrical connection with the luminaire.

7. The adapter device according to claim 1, wherein the at least one resilient element is a leaf spring.

8. The adapter device according to claim 1, wherein the at least one resilient element is electrically conductive and electrically connectable to the electrical interface for electrical connection of the electrical interface with the lighting module.

9. The adapter device according to claim 1, comprising at least one fastening means for releasable attachment of the adapter device to the luminaire.

10. The adapter device according to claim 1, comprising a housing element at least partly enclosing one or more parts of the adapter device.

11. The adapter device according to claim 10, wherein the housing element comprises at least one optical element.

12. A lighting device, comprising
a luminaire,
a lighting module arranged in the luminaire, wherein the lighting module comprises at least one light source and
at least one adapter device as claimed in claim 1 for releasable attachment of the lighting module in the luminaire.

13. The lighting device as claimed in claim 12, wherein the lighting module comprises at least one light-emitting diode and wherein the luminaire is a tube lamp luminaire.

14. The lighting device as claimed in claim 12, wherein the luminaire comprises at least one socket and wherein the electrical interface of the adapter device comprises at least one electrical plug for electrical connection to the at least one socket, wherein the at least one socket is rotatably arranged in the luminaire.

15. The lighting device as claimed in claim 12, wherein the at least one resilient element is electrically conductive and electrically connectable to the electrical interface, and wherein the lighting module comprises at least one electrical contact surface for the at least one resilient element, such that the electrical interface is electrically connectable with the lighting module via the at least one resilient element and the at least one electrical contact surface.
